(19) United States
(12) Patent Application Publication
(10) Pub. No.: US 2024/0201949 A1
(43) Pub. Date: Jun. 20, 2024

(54) SPARSITY-AWARE PERFORMANCE BOOST IN COMPUTE-IN-MEMORY CORES FOR DEEP NEURAL NETWORK ACCELERATION

(71) Applicant: Intel Corporation, Santa Clara, CA (US)

(72) Inventors: Sagar Varma Sayyaparaju, Telangana (IN); Om Ji Omer, Bangalore (IN); Sreenivas Subramoney, Bangalore (IN)

(21) Appl. No.: 18/590,495

(22) Filed: Feb. 28, 2024

(51) Int. Cl. G06F 7/523; G06F 7/50

(52) U.S. Cl. CPC G06F 7/523; G06F 7/50

(57) ABSTRACT

Systems, apparatuses and methods may provide for technology that includes a compute-in-memory (CiM) enabled memory array to conduct digital bit-serial multiply and accumulate (MAC) operations on multi-bit input data and weight data stored in the CiM enabled memory array, an adder tree coupled to the CiM enabled memory array, an accumulator coupled to the adder tree, and an input bit selection stage coupled to the CiM enabled memory array, wherein the input bit selection stage restricts serial bit selection on the multi-bit input data to non-zero values during the digital MAC operations.

### BACKGROUND OF THE DISCLOSURE

A neural network (NN) can be represented as a structure that is a graph of several neuron layers flowing from one layer to the next. The outputs of one layer of neurons, which can be based on calculations, are the inputs of the next layer. To perform these calculations, a variety of matrix-vector, matrix-matrix, and tensor operations may be required, which are themselves comprised of many multiply and accumulate (MAC) operations. Indeed, there are so many of these MAC operations in a neural network, that such operations may dominate other types of computations (e.g., activation and pooling functions). The neural network operation may be enhanced by reducing data fetches from long term storage and distal memories separated from the MAC unit.

Compute-in-memory (CiM) static random-access memory (SRAM) architectures (e.g., merged memory and MAC units) may deliver enhanced performance and energy-efficiency of compute-intensive tasks such as Deep Neural Network (DNN) inference/training through reduced data fetches. Although CiM has been explored using analog and digital techniques, digital CiM provides the advantage of high-precision, high-accuracy and resilience to noise/variations. In general, an integer (INT) mode MAC operation may take place between input and weight mantissas (e.g., for aligned floating point numbers). In such a case, multi-bit inputs are provided to the CiM in a bit-serial fashion, generating partial products that are provided to an adder tree for summation. A challenge of these architectures is that compute cycle time tends to be dominated by bit-serial MAC operations. Moreover, as bit-serial MAC cycles are directly proportional to input bit-width, the performance of CiM cores may worsen for relatively high precision data types such as 16-bit floating point (FP16) and 32-bit floating point (FP32).

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an enhanced digital compute-in-memory (CiM) macro data path with integer (INT) and floating point (FP) compute support according to an embodiment;

FIG. 2 is a signaling diagram of an example of a weight stationary data flow according to an embodiment;

FIG. 3 is a comparative schematic diagram of an example of conventional CiM based MAC hardware and enhanced CiM based MAC hardware according to an embodiment;

FIG. 4 is a schematic diagram of an example of a portion of an input bit selection stage according to an embodiment;

FIG. 5 is an illustration of an example of a Boolean implementation of a leading 1's position detector according to an embodiment;

FIG. 6 is an illustration of an example of a Boolean implementation of a mask bits generator according to an embodiment;

FIG. 7 is a block diagram of an example of a portion of a left shift stage according to an embodiment;

FIG. 8 is a flowchart of an example of a method of operating CiM based MAC hardware according to an embodiment;

FIG. 9 is a flowchart of an example of a method of restricting serial bit selection on multi-bit input data to non-zero values during digital MAC operations according to an embodiment;

FIG. 10 is a block diagram of an example of a performance-enhanced computing system according to an embodiment; and

FIG. 11 is an illustration of an example of a semiconductor package apparatus according to an embodiment.

### DETAILED DESCRIPTION

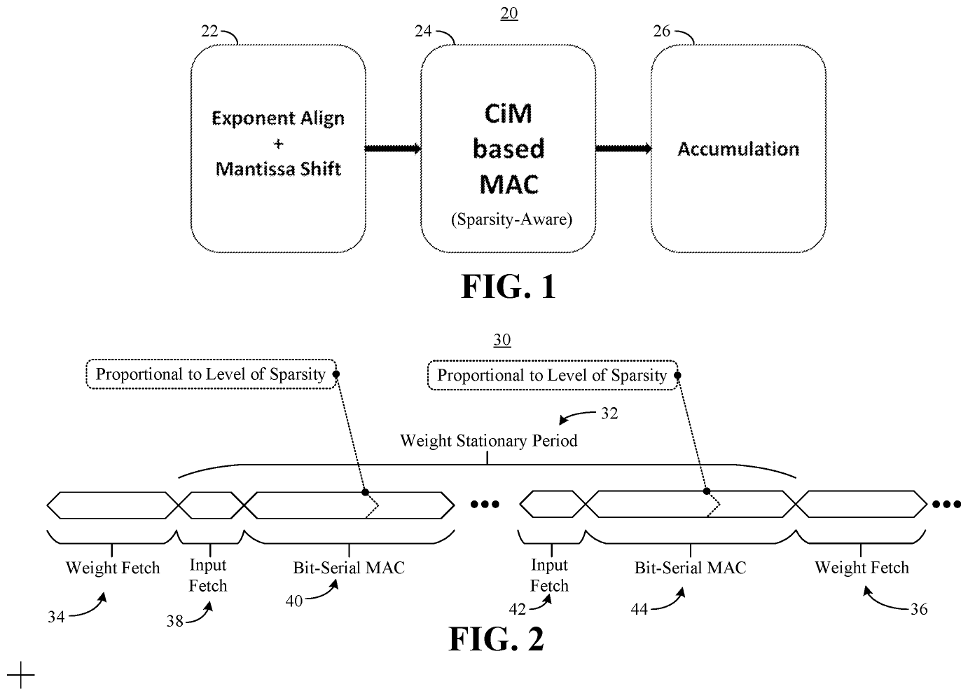

Turning now to FIG. 1, a digital compute-in-memory (CiM) macro data path 20 (e.g., unified pipeline) is shown, wherein the digital CiM macro data path 20 includes integer (INT) and floating point (FP) compute support. In the illustrated example, floating point hardware 22 aligns the exponents of all inputs (e.g., input activations) and their respective mantissas are optionally shifted. In one example, the maximum exponent among the available set of values is used as the aligned exponent. The shifted mantissas of the floating point hardware 22 are in the INT format and are treated as inputs (e.g., multi-bit input data) to CiM based multiply and accumulate (MAC) hardware 24.

The CiM based MAC hardware 24 conducts digital MAC operations (e.g., generating partial products) between input and weight mantissas in an INT mode, wherein the weight mantissas are stored (e.g., “weight stationary”) in the CiM based MAC hardware 24 during the MAC operations. Multi-bit inputs are provided to the CiM based MAC hardware 24 in a bit-serial fashion.

As will be discussed in greater detail, the CiM based MAC hardware 24 is “sparsity-aware” (e.g., serial bit selection on the multi-bit input data is restricted/limited to non-zero values). By adopting a sparsity-aware input handling, the CiM based MAC hardware 24 skips/bypasses unnecessary compute cycles and therefore offers a significant performance boost. Additionally, reduced compute cycles lead to energy savings for the CiM macro. More particularly, exploiting the bit-level sparsity of inputs/activations of deep neural network (DNN) workloads in the context of digital CiM cores provides a performance advantage that is directly proportional to the sparsity of inputs. Additionally, such a solution does not impose any additional constraints on software/compiler frameworks associated with the digital CiM cores/subsystems. Moreover, this solution does not require any pre-training or pruning of workload data. Indeed, the proposed scheme can be adopted by any bit-serial digital CiM macro to provide performance boosts and energy consumption savings.

In one example, the CiM based MAC hardware 24 includes an adder tree (not shown) to sum the partial products resulting from the digital MAC operations. Partial sums generated in the CiM based MAC hardware 24 are shifted (e.g., to account for bit-positions) and provided to accumulation hardware 26 (e.g., accumulation register), which generates outputs.

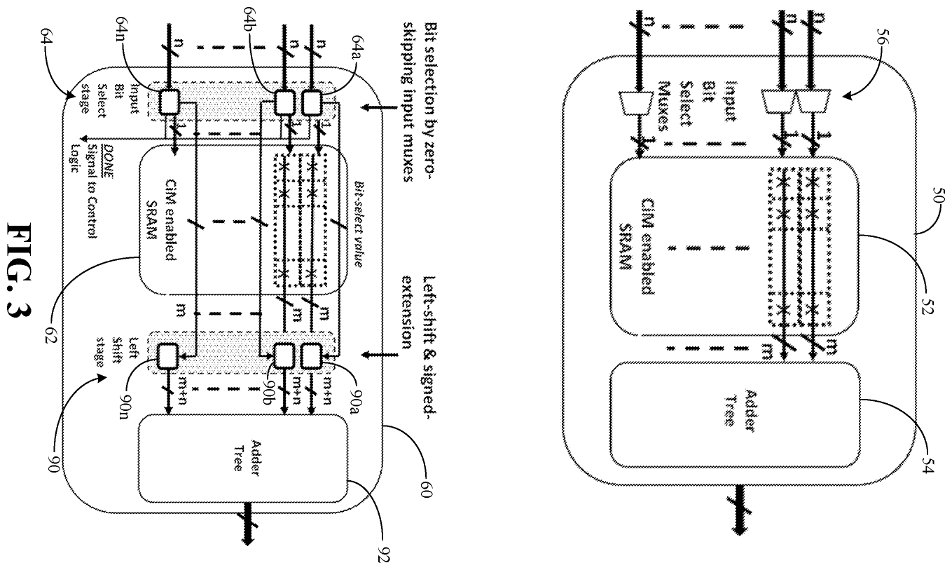

FIG. 2 shows a weight stationary data flow 30 in which a weight stationary period 32 occurs between a first weight fetch 34 and a second weight fetch 36. In the illustrated example, a first input fetch 38 (e.g., retrieving multi-bit input data) is followed by a first bit-serial MAC 40 and an N^{th} input fetch 42 is followed by an N^{th} bit-serial MAC 44. In general, compute cycles are dominated by the latency of the bit-serial MACs 40, 44. Moreover, the compute cycles consumed by the bit-serial MACs 40, 44 are proportional to the bit-width of the input data retrieved during the input fetches 38, 42 (e.g., a greater bit-width consumes more compute cycles). Thus, restricting serial bit selection on the multi-bit input data to non-zero values as described herein (e.g., sparsity awareness) reduces the duration of the bit-serial MACs 40, 44 for sparse workloads, which in turn provides performance and energy consumption advantages. Indeed, such an approach enables relatively high precision data types such as 16-bit floating point (FP16) and 32-bit floating point (FP32) to be used without concern over performance degradation.

FIG. 3 shows a conventional CiM based MAC hardware 50 in which an INTmode MAC operation takes place between the input and weight mantissas. In a bit-serial MAC approach, 1-bit of each input is selected per cycle and provided to a memory array 52 (e.g., CiM-enabled static random access memory/SRAM). At each bitcell of the memory array 52, a 1-bit AND operation is performed, wherein each row of the memory array 52 outputs the product of: 1-bit input x m-bit weight. The summation of these products is performed by an adder tree 54, which generates the output of the conventional CiM based MAC hardware 50. As already noted, the partial sum from the conventional CiM based MAC hardware 50 may be left-shifted appropriately and added to the current partial sum in an accumulation register, generating a newer set of outputs. The final output corresponding to the MAC result is generated after the final cycle of bit-serial computation. The undetected input sparsity of the conventional CiM based MAC hardware 50 leads to wasted compute cycles for sparse workloads, because when the input bit selected by input multiplexers 56 is zero, the compute output is known to be zero.

An enhanced CiM based MAC hardware 60 addresses this issue by introducing hardware enhancements to digital CiM that will skip zeroes during bit-serial compute, which enhances performance. Thus, in the case of dense compute, for any given compute cycle, all the input multiplexers 56 in the conventional CiM based MAC hardware 50 will choose the same input bit position for each of their inputs. By contrast, for sparse compute, the enhanced CiM based MAC hardware 60 only selects non-zero bit positions. Since the input at each row of the memory array 62 (e.g., CiM enabled SRAM) will be unique, an input bit selection stage 64 (64a-64n) includes separate/unique input multiplexers (muxes).

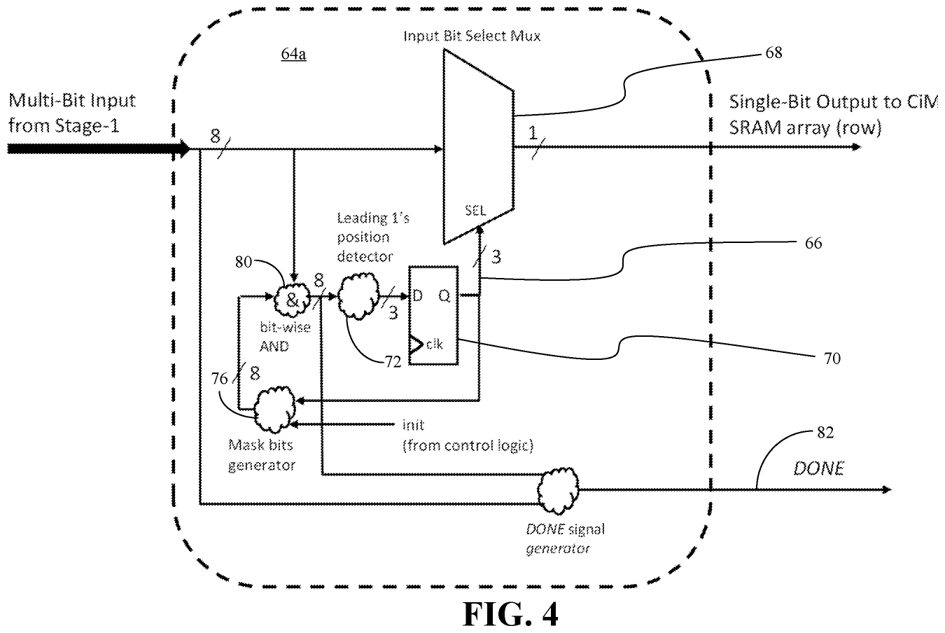

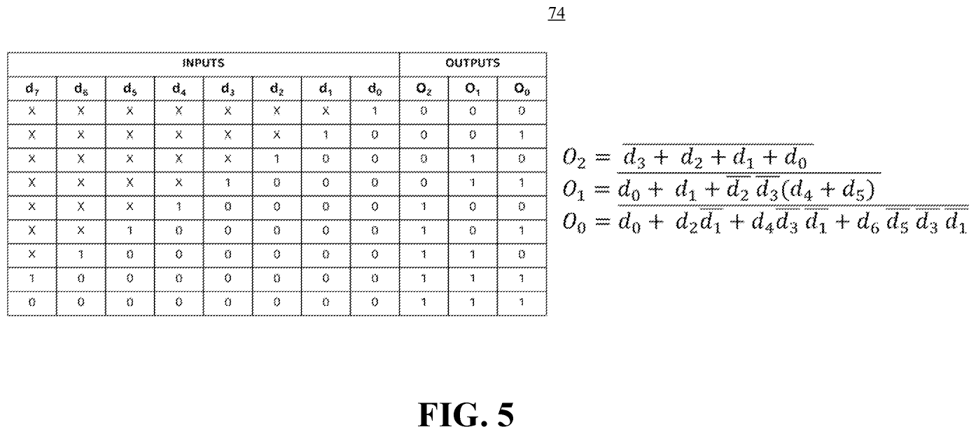

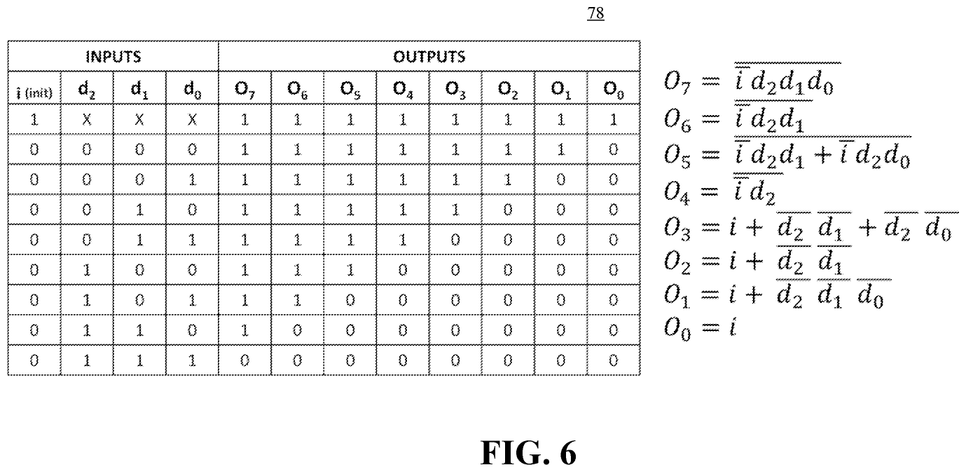

With continued reference to FIGS. 4-6, a portion 64a of the input bit selection stage 64 (FIG. 3) is shown in greater detail. In the illustrated example, selection bits 66 of a multiplexer 68 are driven by a local register 70, which stores the selection value. This selection value is determined by a “leading 1's position detector” 72. This position detector 72 outputs the position of the first occurring non-zero value (e.g., “1” count starting from the least significant bit/LSB) in a given multi-bit input. In an embodiment, the position detector 72 implements a Boolean configuration 74. For the first cycle of compute, the input of the position detector 72 is the same as the input vector. For later cycles, the bit positions that have been processed in previous cycles are masked to enable the encoder to detect the next occurring non-zero value.

Accordingly, a mask bits generator 76 generates an output that identifies all of the bit positions that have already been processed. In an embodiment, the mask bits generator 76 implements a Boolean configuration 78. A binary operator 80 conducts a bit-wise AND between the generated mask bits and the input element value to generate the next input for the position detector 72.

During the bit-serial compute, when all bit positions with a ‘1’ have been processed, a DONE (e.g., completion) signal 82 is asserted. This signal 82 takes on a value of ‘1’ when the input to the position detector 72 is a ZERO while the input contains at least one non-zero bit OR when the input itself is a ZERO. This condition is represented as follows:

$$DONE = ! ( \vert ( {i}_{7} {i}_{6} {i}_{5} {i}_{4} {i}_{3} {i}_{2} {i}_{1} {i}_{0} ) ) ‖ ( ( \vert ( {i}_{7} {i}_{6} {i}_{5} {i}_{4} {i}_{3} {i}_{2} {i}_{I} {i}_{0} ) \& \& ( ! ( \vert ( {d}_{7} {d}_{6} {d}_{5} {d}_{4} {d}_{3} {d}_{2} {d}_{1} {d}_{0} ) ) )$$

Where i₇i₆i₅i₄i₃i₂i₁i₀ represents the input and d₇d₆d₅d₄d₃d₂d₁d₀ represents input to the position detector 72. Since each of the SRAM rows performs a multiply operation independently, with different sparsity levels for each input value, the DONE signal 82 from each of the rows is used to detect the completion of the MAC operation for the macro. Thus, the completion/DONE signals 82 indicate that all bit positions in the multi-bit input data with the non-zero values have been processed. When the DONE signal 82 from all the rows is asserted, control logic (not shown) of the CiM macro may proceed further with the workload execution and load the next set of inputs into the FP hardware of the data path.

The operations described above will lead to only non-zero bit positions being selected in the inputs. Hence, compute cycles per input will be directly proportional to the density of 1's in the input (e.g., the sparser the input, the quicker the compute). Table I below demonstrates this proportionality.

TABLE I

| | Sample 8-bit Input Value: 00100101 | | | | |
|---|---|---|---|---|---|
| | Proposed Zero-Skipping Mux | | | | |
| | Input to | Input | | Conventional Bit-Serial | |
| | leading | mux's | | Mux (Dense Compute) | |
| | one's | select | Mux's | Input mux's | Mux's |
| | detector | bits | output | select bits | Output |
| Cycle-0 | 00100100 | 0 | 1 | 0 | 1 |
| Cycle-1 | 00100000 | 2 | 1 | 1 | 0 |
| Cycle-2 | 00000000 | 5 | 1 | 2 | 1 |
| Cycle-3 | —NA— | —NA— | —NA— | 3 | 0 |
| Cycle-4 | —NA— | —NA— | —NA— | 4 | 0 |
| Cycle-5 | —NA— | —NA— | —NA— | 5 | 1 |
| Cycle-6 | —NA— | —NA— | —NA— | 6 | 0 |
| Cycle-7 | —NA— | —NA— | —NA— | 7 | 0 |

It can be seen from the example in Table I that, with dense compute, the MAC operation takes 8 bit-serial cycles. With the zero-skipping mux technology described herein, the same bit-serial MAC is achieved in three cycles (e.g., equal to the total number of 1's in the input).

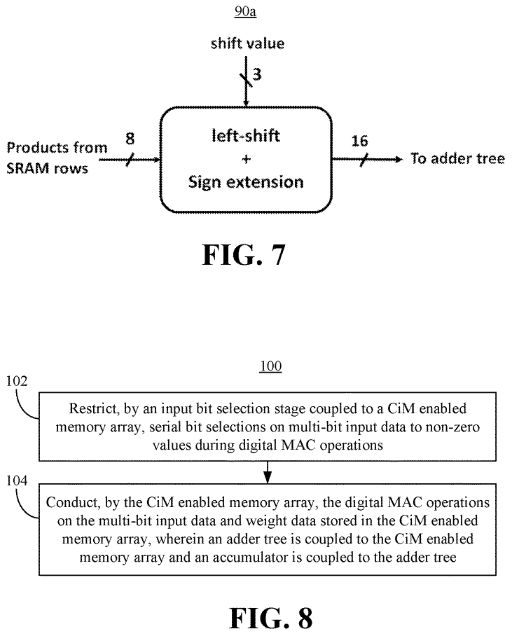

With continuing reference to FIGS. 3 and 7, since the compute for each input element (e.g., at each SRAM row) is handled independently, the left shift operation (e.g., to account for bit-serial MAC) is now part of a left shift stage 90 (90a-90n) in the enhanced CiM based MAC hardware 60. The shift amount in any given cycle is the same as the corresponding bit selection value of the multiplexer. In a given compute cycle, each input value will have a respective bit selection position, and hence a unique shift operation is performed for products arising from each row of the memory array 62 (e.g., left shift operations are conducted on an output of the CiM enabled memory array on a per memory row basis). The shifted products are sign extended to the maximum possible width (e.g., equal to 16, for the case of 8-bit inputs and weights), and provided to an adder tree 92 for summation.

FIG. 8 shows a method 100 of operating CiM based MAC hardware. The method 100 may generally be implemented in CiM based MAC hardware such as, for example, the enhanced CiM based MAC hardware 60 (FIG. 3), already discussed. More particularly, the method 100 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 100 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 102 restricts, by an input bit selection stage coupled to a CiM enabled memory array, serial bit selection on multi-bit input data to non-zero values during digital MAC operations. Block 104 conducts, by the CiM enabled memory array, the digital MAC operations on the multi-bit input data and weight data stored in the CiM enabled memory array, wherein an adder tree is coupled to the CiM enabled memory array and an accumulator is coupled to the adder tree. In an embodiment, the number of cycles consumed by the CiM enabled memory array during the digital MAC operations is proportional to the level of sparsity in the multi-bit input data. The method 100 therefore enhances performance at least to the extent that restricting serial bit selection on the multi-bit input data to non-zero values reduces the number of compute cycles consumed during digital MAC operations in the presence of sparse input data. The method 100 also reduces energy consumption of sparse artificial intelligence (AI) workloads during inference and training.

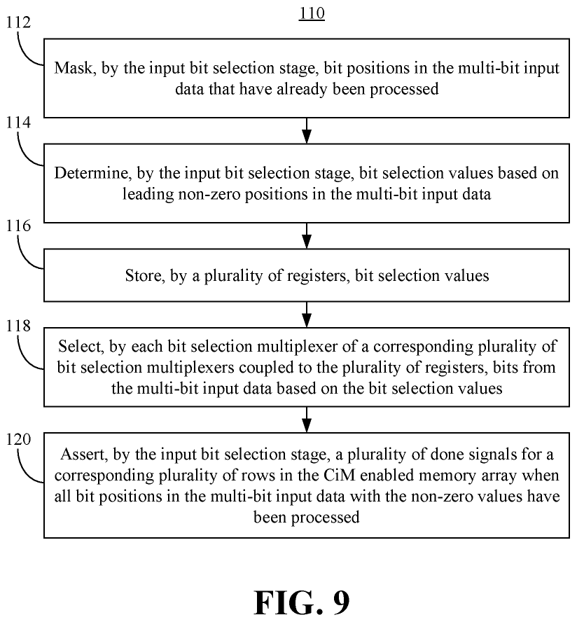

FIG. 9 shows a method 110 of restricting serial bit selection on multi-bit input data to non-zero values. The method 110 may generally be incorporated into block 102 (FIG. 8), already discussed. More particularly, the method 110 may be implemented in one or more modules as a set of logic instructions stored in a machine- or computer-readable storage medium RAM, ROM, PROM, firmware, flash memory, etc., in hardware, or any combination thereof.

Illustrated processing block 112 provides for masking, by the input bit selection stage, bit positions in the multi-bit input data that have already been processed. Additionally, block 114 may determine, by the input bit selection stage, bit selection values based on leading non-zero positions in the multi-bit input data. In one example, block 116 stores, by a plurality of registers, bit selection values, wherein block 118 selects, by each bit selection multiplexer of a corresponding plurality of bit selection multiplexers coupled to the plurality of registers, bits from the multi-bit input data based on the bit selection values. In addition, block 120 asserts, by the input bit selection stage, a plurality of done (e.g., DONE) signals for a corresponding plurality of rows in the CiM enabled memory array when all bit positions in the multi-bit input data with the non-zero values have been processed.

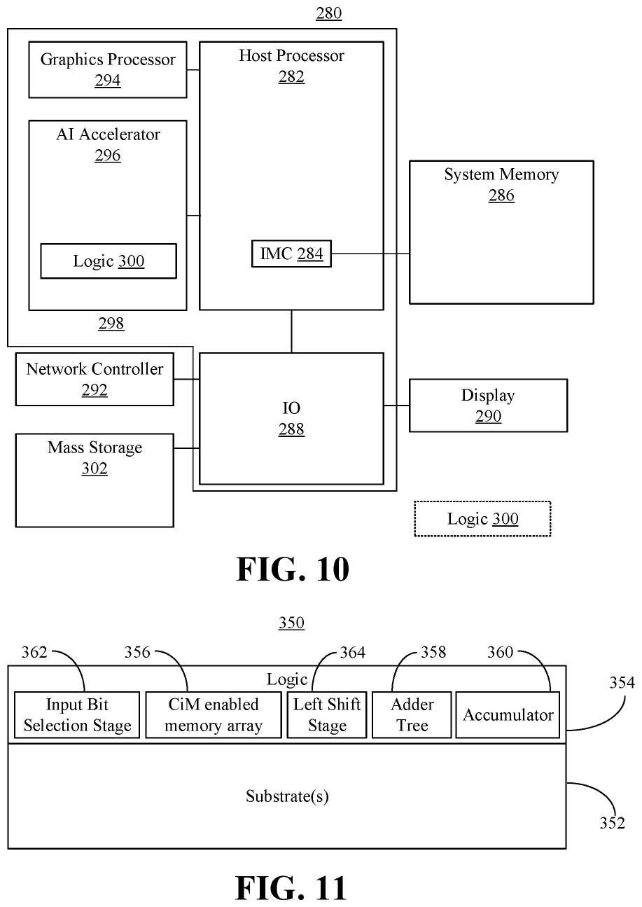

Turning now to FIG. 10, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IOT) functionality, drone functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 into a system on chip (SoC) 298.

In an embodiment, the AI accelerator 296 contains logic 300 (e.g., configurable and/or fixed-functionality hardware) that implements one or more aspects of the method 100 (FIG. 8) and/or the method 110 (FIG. 9), already discussed. Thus, the logic 300 includes a CiM enabled memory array to conduct digital bit-serial MAC operations on multi-bit input data and weight data stored in the CiM enabled memory array. The logic 300 also includes an adder tree coupled to the CiM enabled memory array, a left shift stage coupled to the CiM enabled memory array and the adder tree, an accumulator coupled to the adder tree, and an input bit selection stage coupled to the CiM enabled memory array. The input bit selection stage restricts serial bit selection on the multi-bit input data to non-zero values during the digital MAC operations. Although the logic 300 is shown within the AI accelerator 296, the logic 300 may also reside elsewhere in the computing system 280.

The computing system 280 therefore enhances performance at least to the extent that restricting serial bit selection on the multi-bit input data to non-zero values reduces the number of compute cycles consumed during digital MAC operations in the presence of sparse input data. The computing system 280 also reduces energy consumption of sparse artificial intelligence (AI) workloads during inference and training.

FIG. 11 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 100 (FIG. 8) and/or the method 110 (FIG. 9), already discussed. Thus, the logic 354 includes a CiM enabled memory array 356 (e.g., SRAM) to conduct digital bit-serial MAC operations on multi-bit input data and weight data stored in the CiM enabled memory array 356, an adder tree 358 coupled to the CiM enabled memory array 356, an accumulator 360 coupled to the adder tree 358, and an input bit selection stage 362 coupled to the CiM enabled memory array 356, wherein the input bit selection stage 362 restricts serial bit selection on the multi-bit input data to non-zero values during the digital MAC operations. The logic 354 may also include a left shift stage 364 coupled to the CiM enabled memory array 356 and the adder tree 358, wherein the left shift stage conducts left shift operations and sign extension on an output of the CiM enabled memory array 356 on a per memory row basis.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

### Additional Notes and Examples

Example 1 includes a performance-enhanced computing system comprising a network controller and a processor coupled to the network controller, wherein the processor includes logic coupled to one or more substrates, the logic including a compute-in-memory (CiM) enabled memory array to conduct digital bit-serial multiply and accumulate (MAC) operations on multi-bit input data and weight data stored in the CiM enabled memory array, an adder tree coupled to the CiM enabled memory array, a left shift stage coupled to the CiM enabled memory array and the adder tree, an accumulator coupled to the adder tree, and an input bit selection stage coupled to the CiM enabled memory array, the input bit selection stage to restrict serial bit selection on the multi-bit input data to non-zero values during the digital MAC operations.

Example 2 includes the computing system of Example 1, wherein a number of cycles consumed by the CiM enabled memory array during the digital MAC operations is to be proportional to a level of sparsity in the multi-bit input data.

Example 3 includes the computing system of Example 1, wherein the input bit selection stage includes a plurality of registers, wherein each register is to store bit selection values, a corresponding plurality of bit selection multiplexers coupled to the plurality of registers, wherein each bit selection multiplexer is to select bits from the multi-bit input data based on the bit selection values.

Example 4 includes the computing system of Example 3, wherein the input bit selection stage is to determine the bit selection values based on leading non-zero positions in the multi-bit input data.

Example 5 includes the computing system of Example 1, wherein the input bit selection stage is to mask bit positions in the multi-bit input data that have already been processed.

Example 6 includes the computing system of any one of Examples 1 to 5, wherein the input bit selection stage is to assert a plurality of completion signals for a corresponding plurality of rows in the CiM enabled memory array, and wherein the completion signals indicate that all bit positions in the multi-bit input data with the non-zero values have been processed.

Example 7 includes a semiconductor apparatus comprising one or more substrates, and logic coupled to the one or more substrates, wherein the logic is implemented at least partly in one or more of configurable or fixed-functionality hardware, the logic including a compute-in-memory (CiM) enabled memory array to conduct digital bit-serial multiply and accumulate (MAC) operations on multi-bit input data and weight data stored in the CiM enabled memory array, an adder tree coupled to the CiM enabled memory array, an accumulator coupled to the adder tree, and an input bit selection stage coupled to the CiM enabled memory array, the input bit selection stage to restrict serial bit selection on the multi-bit input data to non-zero values during the digital MAC operations.

Example 8 includes the semiconductor apparatus of Example 7, wherein a number of cycles consumed by the CiM enabled memory array during the digital MAC operations is to be proportional to a level of sparsity in the multi-bit input data.

Example 9 includes the semiconductor apparatus of Example 7, wherein the input bit selection stage includes a plurality of registers, wherein each register is to store bit selection values, a corresponding plurality of bit selection multiplexers coupled to the plurality of registers, wherein each bit selection multiplexer is to select bits from the multi-bit input data based on the bit selection values.

Example 10 includes the semiconductor apparatus of Example 9, wherein the input bit selection stage is to determine the bit selection values based on leading non-zero positions in the multi-bit input data.

Example 11 includes the semiconductor apparatus of Example 7, wherein the input bit selection stage is to mask bit positions in the multi-bit input data that have already been processed.

Example 12 includes the semiconductor apparatus of Example 7, wherein the input bit selection stage is to assert a plurality of completion signals for a corresponding plurality of rows in the CiM enabled memory array, and wherein the completion signals indicate that all bit positions in the multi-bit input data with the non-zero values have been processed.

Example 13 includes the semiconductor apparatus of any one of Examples 7 to 12, wherein the logic further includes a left shift stage coupled to the CiM enabled memory array and the adder tree, and wherein the left shift stage is to conduct left shift operations and sign extension on an output of the CiM enabled memory array on a per memory row basis.

Example 14 includes the semiconductor apparatus of any one of Examples 7 to 12, wherein the logic coupled to the one or more substrates includes transistor channel regions that are positioned within the one or more substrates.

Example 15 includes a method of operating a performance-enhanced computing system, the method comprising conducting, by a compute-in-memory (CiM) enabled memory array, digital bit-serial multiply and accumulate (MAC) operations on multi-bit input data and weight data stored in the CiM enabled memory array, wherein an adder tree is coupled to the CiM enabled memory array and an accumulator is coupled to the adder tree, restricting, by an input bit selection stage coupled to the CiM enabled memory array, serial bit selection on the multi-bit input data to non-zero values during the digital MAC operations.

Example 16 includes the method of Example 15, wherein a number of cycles consumed by the CiM enabled memory array during the digital MAC operations is proportional to a level of sparsity in the multi-bit input data.

Example 17 includes the method of Example 15, further including storing, by a plurality of registers, bit selection values, and selecting, by each bit selection multiplexer of a corresponding plurality of bit selection multiplexers coupled to the plurality of registers, bits from the multi-bit input data based on the bit selection values.

Example 18 includes the method of Example 17, further including determining, by the input bit selection stage, the bit selection values based on leading non-zero positions in the multi-bit input data.

Example 19 includes the method of Example 15, further including masking, by the input bit selection stage, bit positions in the multi-bit input data that have already been processed.

Example 20 includes the method of any one of Examples 15 to 19, further including asserting, by the input bit selection stage, a plurality of completion signals for a corresponding plurality of rows in the CiM enabled memory array, and wherein the completion signals indicate that all bit positions in the multi-bit input data with the non-zero values have been processed.

Example 21 includes an apparatus comprising means for performing the method of any one of Examples 15 to 20.

Technology described herein therefore provides a sparsity-aware CiM macro that significantly boosts the performance of conventional and emerging AI workloads having a large portion of input data that is sparse. Embodiments also reduce energy consumption of sparse AI workloads during inference and/or training, by skipping unnecessary compute cycles and avoiding unnecessary switching activity in hardware. The technology described herein can be applied to CiM macros processing a variety of datatypes such as 8-bit integer (INT8), 16-bit Brain floating point (BF16), 16-bit floating point (FP16) and 32-bit floating point (FP32) and proves more valuable in saving long MAC computational phases for higher precisions of compute. Accordingly, the technology described herein is widely applicable—for CiM hardware executing inference or training applications—and offers performance boost and energy efficiency for both cloud and edge processing. Additionally, the technology described herein does not impose any special requirements or restrictions on the software/compiler that schedules workload execution on CiM hardware. Accordingly, embodiments can be adopted with no changes to software stack.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller; and
a processor coupled to the network controller, wherein the processor includes logic coupled to one or more substrates, the logic including:
a compute-in-memory (CiM) enabled memory array to conduct digital bit-serial multiply and accumulate (MAC) operations on multi-bit input data and weight data stored in the CiM enabled memory array,
an adder tree coupled to the CiM enabled memory array,
a left shift stage coupled to the CiM enabled memory array and the adder tree,
an accumulator coupled to the adder tree, and
an input bit selection stage coupled to the CiM enabled memory array, the input bit selection stage to restrict serial bit selection on the multi-bit input data to non-zero values during the digital MAC operations.

2. The computing system of claim 1, wherein a number of cycles consumed by the CiM enabled memory array during the digital MAC operations is to be proportional to a level of sparsity in the multi-bit input data.

3. The computing system of claim 1, wherein the input bit selection stage includes:
a plurality of registers, wherein each register is to store bit selection values,
a corresponding plurality of bit selection multiplexers coupled to the plurality of registers, wherein each bit selection multiplexer is to select bits from the multi-bit input data based on the bit selection values.

4. The computing system of claim 3, wherein the input bit selection stage is to determine the bit selection values based on leading non-zero positions in the multi-bit input data.

5. The computing system of claim 1, wherein the input bit selection stage is to mask bit positions in the multi-bit input data that have already been processed.

6. The computing system of claim 1, wherein the input bit selection stage is to assert a plurality of completion signals for a corresponding plurality of rows in the CiM enabled memory array, and wherein the completion signals indicate that all bit positions in the multi-bit input data with the non-zero values have been processed.

7. A semiconductor apparatus comprising:
one or more substrates; and
logic coupled to the one or more substrates, wherein the logic is implemented at least partly in one or more of configurable or fixed-functionality hardware, the logic including:
a compute-in-memory (CiM) enabled memory array to conduct digital bit-serial multiply and accumulate (MAC) operations on multi-bit input data and weight data stored in the CiM enabled memory array;
an adder tree coupled to the CiM enabled memory array;
an accumulator coupled to the adder tree; and
an input bit selection stage coupled to the CiM enabled memory array, the input bit selection stage to restrict serial bit selection on the multi-bit input data to non-zero values during the digital MAC operations.

8. The semiconductor apparatus of claim 7, wherein a number of cycles consumed by the CiM enabled memory array during the digital MAC operations is to be proportional to a level of sparsity in the multi-bit input data.

9. The semiconductor apparatus of claim 7, wherein the input bit selection stage includes:
a plurality of registers, wherein each register is to store bit selection values;
a corresponding plurality of bit selection multiplexers coupled to the plurality of registers, wherein each bit selection multiplexer is to select bits from the multi-bit input data based on the bit selection values.

10. The semiconductor apparatus of claim 9, wherein the input bit selection stage is to determine the bit selection values based on leading non-zero positions in the multi-bit input data.

11. The semiconductor apparatus of claim 7, wherein the input bit selection stage is to mask bit positions in the multi-bit input data that have already been processed.

12. The semiconductor apparatus of claim 7, wherein the input bit selection stage is to assert a plurality of completion signals for a corresponding plurality of rows in the CiM enabled memory array, and wherein the completion signals indicate that all bit positions in the multi-bit input data with the non-zero values have been processed.

13. The semiconductor apparatus of claim 7, wherein the logic further includes a left shift stage coupled to the CiM enabled memory array and the adder tree, and wherein the left shift stage is to conduct left shift operations and sign extension on an output of the CiM enabled memory array on a per memory row basis.

14. The semiconductor apparatus of claim 7, wherein the logic coupled to the one or more substrates includes transistor channel regions that are positioned within the one or more substrates.

15. A method comprising:
conducting, by a compute-in-memory (CiM) enabled memory array, digital bit-serial multiply and accumulate (MAC) operations on multi-bit input data and weight data stored in the CiM enabled memory array, wherein an adder tree is coupled to the CiM enabled memory array and an accumulator is coupled to the adder tree;
restricting, by an input bit selection stage coupled to the CiM enabled memory array, serial bit selection on the multi-bit input data to non-zero values during the digital MAC operations.

16. The method of claim 15, wherein a number of cycles consumed by the CiM enabled memory array during the digital MAC operations is proportional to a level of sparsity in the multi-bit input data.

17. The method of claim 15, further including:
storing, by a plurality of registers, bit selection values; and
selecting, by each bit selection multiplexer of a corresponding plurality of bit selection multiplexers coupled to the plurality of registers, bits from the multi-bit input data based on the bit selection values.

18. The method of claim 17, further including determining, by the input bit selection stage, the bit selection values based on leading non-zero positions in the multi-bit input data.

19. The method of claim 15, further including masking, by the input bit selection stage, bit positions in the multi-bit input data that have already been processed.

20. The method of claim 15, further including asserting, by the input bit selection stage, a plurality of completion signals for a corresponding plurality of rows in the CiM enabled memory array, and wherein the completion signals indicate that all bit positions in the multi-bit input data with the non-zero values have been processed.
